(19) United States
(12) Patent Application Publication
(10) Pub. No.: US 2026/0365127 A1
(43) Pub. Date: Nov. 19, 2026

(54) LAYER-BASED SOFTWARE-DEFINED VEHICLE ARCHITECTURE AND CONTROL METHOD THEREOF

(71) Applicants: HYUNDAI MOTOR COMPANY, Seoul (KR); Kia Corporation, Seoul (KR)

(72) Inventors: Jae Won LEE, Hwaseong-si (KR); Soung Han NOH, Hwaseong-si (KR); Bong Kyu CHOI, Hwaseong-si (KR); In Sung JUNG, Hwaseong-si (KR); Jae Hyeon PARK, Hwaseong-si (KR)

(21) Appl. No.: 19/530,049

(22) Filed: Feb. 4, 2026

(30) Foreign Application Priority Data
May 16, 2025 (KR) 10-2025-0064206

(51) Int. Cl. B60R 16/023; H04L 67/12

(52) U.S. Cl. CPC B60R 16/0231; H04L 67/12

(57) ABSTRACT

Disclosed is a layer-based software-defined vehicle architecture which includes a driver layer including a driver for performing an operation and control for a physical layer including each individual device of a vehicle, a B zonal layer that includes a zone controller for performing zone control for each predetermined zone for the vehicle and delivers a control signal to a driver of the zone to control an operation of an individual device included in a physical layer of the zone, and a vehicle integration layer including an integrated controller for controlling the zone controller in an integrated manner.

### CROSS-REFERENCE TO RELATED APPLICATION

This application claims the benefit of priority to Korean Patent Application No. 10-2025-0064206, filed in the Korean Intellectual Property Office on May 16, 2025, the entire contents of which are incorporated herein by reference.

### TECHNICAL FIELD

The present disclosure relates to a layer-based software-defined (SDV) architecture, and more particularly, relates to a layer-based SDV architecture for collecting advantages of a domain architecture and a zonal architecture to ensure software flexibility and independence and a control method thereof.

### BACKGROUND

The matters described in this Background section are only for enhancement of understanding of the background of the disclosure, and should not be taken as acknowledgment that they correspond to prior art already known to those skilled in the art.

The popularization of smartphones, the development of high-performance data technology, and the emergence of electric vehicles have raised expectations that vehicles will evolve from mere machines into smart vehicles incorporating advanced software (SW) technology. These expectations are being realized through the development of the software-defined vehicle (SDV) concept, which extends the idea of software definition found in software-defined networks (SDN) and software-defined manufacturing (SDM).

A method for developing and adapting to the SDV is being established across various fields, such as original equipment manufacturers (OEMs), different tiers of suppliers, development tool suppliers, or part suppliers. However, there remains a lack of consideration from the perspective of actual vehicle implementation. For example, certain approaches focus solely on software (SW) development structures, forced configurations without accounting for vehicle architecture, or insufficient reflection of mass production design specifications, legal compliance, and regulatory requirements. As a result, many such methods are difficult to apply effectively to real-world vehicles.

### SUMMARY

The present disclosure has been made to solve the above-mentioned problems.

An example of the present disclosure provides a layer-based SDV architecture for collecting only advantages of a domain architecture and a zonal architecture to ensure software flexibility and independence and a control method thereof.

The technical problems to be solved by the present disclosure are not limited to the aforementioned problems, and any other technical problems not mentioned herein will be clearly understood from the following description by those skilled in the art to which the present disclosure pertains.

According to the present disclosure, an apparatus of a vehicle may comprise a physical layer associated with a plurality of circuits of the vehicle, a driver layer configured to perform operation and control of the physical layer, and a zonal layer that may comprise a plurality of zone controllers configured to perform zone control for respective predetermined zones of the vehicle, where each predetermined zone is associated with a corresponding portion of the physical layer, and output a control signal to a driver associated with each predetermined zone to control an operation of a circuit associated with the corresponding portion of the physical layer. The apparatus may further comprise a vehicle integration layer that may comprise an integrated controller configured to control each of the plurality of zone controllers in an integrated manner.

The driver layer, the zonal layer, and the vehicle integration layer may be coupled with each other via a standardized interface, and at least one of the driver layer, the zonal layer, or the vehicle integration layer may be updatable, via the standardized interface, independently from a corresponding physical component of the vehicle.

The circuit may be further associated with a body of the vehicle and included in the respective predetermined zone of the vehicle.

Each zone controller may be configured to communicate, via a standardized interface, with a driver associated with a respective predetermined zone.

The integrated controller may be configured to provide control signals to a power transmission system driver of the driver layer, a chassis driver of the driver layer, and a safety driver of the driver layer for respectively performing power transmission system control, chassis control, and safety control.

The integrated controller may be configured to receive a user input, determine, based on a user experience (UX)-based user scenario, a predetermined external service corresponding to the user input, and invoke the predetermined external service, where the predetermined external service may comprise at least one of a body domain service or a vehicle dynamics control service.

An energy layer associated with a power conversion circuit may be included and configured to perform power-to-power conversion between the vehicle and a power grid based on respective operating voltages of the vehicle and the power grid, and supply control power and driving power to the vehicle.

According to the present disclosure, a method performed by an apparatus of a vehicle may comprise providing, via a standardized interface of the vehicle and by a zone controller of a plurality of zone controllers associated with respective zones of the vehicle, a control signal associated with a body of the vehicle; controlling, by a driver associated with each respective zone and based on the control signal, an operation of a circuit of a plurality of circuits of the vehicle, where the circuit is associated with the corresponding zone; and controlling, by an integrated controller of the vehicle, each of the plurality of zone controllers in an integrated manner.

Providing the control signal may comprise transmitting the control signal via the standardized interface.

Controlling each of the plurality of zone controllers may comprise performing power transmission system control, chassis control, and safety control.

The method may further comprise receiving a user input, determining, based on a user experience (UX)-based user scenario, a predetermined external service corresponding to the user input, and invoking the predetermined external service, where the predetermined external service may comprise at least one of a body domain service or a vehicle dynamics control service.

According to the present disclosure, a vehicle may comprise a sensor configured to obtain information on the vehicle and a surrounding environment of the vehicle, an actuator configured to perform a physical operation of the vehicle based on a control signal, a driver layer configured to operate the actuator based on the control signal, a zonal layer configured to perform zone control for a predetermined zone of the vehicle in and provide the control signal to the driver layer, and a vehicle integration layer configured to control the zonal layer to perform control of at least one of a powertrain system, a chassis system, or a safety system of the vehicle. The vehicle may further comprise interfaces configured to exchange data between the driver layer, the zonal layer, and the vehicle integration layer, a driving control circuit configured to control autonomous driving of the vehicle, and a processor circuit configured to output, via the interfaces and based on the information obtained by the sensor, driving control signals respectively for controlling the driver layer, the zonal layer, and the vehicle integration layer, and to control, via the driving control circuit and based on the driving control signals, autonomous driving of the vehicle.

The processor circuit may be configured to determine, based on information obtained by the sensor, a user experience (UX)-based user scenario associated with autonomous driving of the vehicle, and output at least one driving control signal based on the UX-based user scenario.

The processor circuit may be configured to determine, based on information obtained by the sensor, a user experience (UX)-based user scenario, to identify an external service corresponding to the UX-based user scenario, and initiate communication with the external service, where the external service may comprise at least one of a body domain service or a vehicle dynamics control service, where the body domain service corresponds to a service associated with at least one of a door, window, lighting, or climate control of the vehicle, and where the vehicle dynamics control service corresponds to a service associated with at least one of a powertrain system, a chassis system, or a safety system of the vehicle.

The processor circuit may be configured to transmit, via the interfaces, a control signal to a zone controller of the zonal layer, where the zone controller is associated with a respective zone of the vehicle and configured to provide the control signal to a driver of the respective zone to control a circuit associated with a body of the vehicle.

The processor circuit may be configured to control, via the vehicle integration layer, a plurality of zone controllers included in the zonal layer to perform integrated control of at least two among a powertrain system, a chassis system, and a safety system of the vehicle.

The processor circuit may be configured to perform power-to-power conversion control by transmitting a control signal to a power conversion circuit associated with an energy layer of the vehicle, where the power conversion circuit is configured to perform power conversion between the vehicle and a power grid based on respective operating voltages of the vehicle and the power grid.

The processor circuit may be configured to update, via the interfaces, at least one of the driver layer, the zonal layer, or the vehicle integration layer independently from a corresponding physical component of the vehicle.

The processor circuit may be configured to establish, via the interfaces, a connection between a driver of the driver layer and a zone controller of the zonal layer such that a software configuration of the zone controller is not required to be changed when hardware associated with the driver is added or changed.

The processor circuit may be configured to control communication between the driver layer and a physical layer of the vehicle to operate a plurality of circuits of the vehicle, where the plurality of circuits may be operated based on respective control signals from the driver layer.

The features briefly summarized above with respect to the present disclosure are merely examples of the detailed description of the present disclosure, which will be described below, and do not limit the scope of the present disclosure.

### BRIEF DESCRIPTION OF THE DRAWINGS

The above and other objects, features and advantages of the present disclosure will be more apparent from the following detailed description taken in conjunction with the accompanying drawings:

FIG. 1 shows an exemplary drawing for a zonal architecture;

FIG. 2A shows an example of a layer-based software-defined vehicle architecture;

FIG. 2B shows an exemplary drawing for a layer-based software-defined vehicle architecture including an energy layer;

FIG. 3 shows an exemplary drawing for describing an operation in a high-performance computer (HPC);

FIG. 4 shows an exemplary operational flowchart for a layer-based software-defined vehicle control method; and

FIG. 5 shows an example of a block diagram of a computing system for executing a layer-based software-defined vehicle control method.

### DETAILED DESCRIPTION

Hereinafter, an example of the present disclosure will be described more fully with reference to the accompanying drawings to such an extent as to be easily embodied by one skilled in the art. However, the present disclosure may be embodied in many different forms and should not be construed as being limited to the example set forth herein.

In describing an example of the present disclosure, when it is determined that a detailed description of a well-known configuration or function may obscure the gist of the present disclosure, a detailed description thereof will be omitted. Parts not related to the description of the present disclosure are omitted in the drawings, and similar parts are denoted by similar reference numerals throughout the specification.

In the disclosed example, when it is described that any component is “connected” or “coupled” to another component, the component may be directly connected or coupled to another component, but it should be understood that any other component may also be “interposed” therebetween. In addition, when one component is referred to as “comprising”, “including” or “having” another component, it is meant that the component may further include other components without excluding other components as long as there is no contrary description.

In the disclosed example, the terms “first,” “second,” and the like are merely used for distinguishing one component from the other components and do not limit order, importance, or the like between components unless specifically stated. Thus, a first component in an example in the scope of the present disclosure may be referred to as a second component in another example in the scope of the present disclosure. Likewise, a second component in an example may be referred to as a first component in another example.

In the disclosed example, components distinguished from each other are only to clearly describe respective features and do not mean that components must be separated. In other words, a plurality of components may be integrated to form a single hardware or software unit, or a single component may be distributed to form a plurality of hardware or software units. Thus, even if not specifically mentioned, the integrated or separate examples are also included in the scope of the present disclosure.

In the disclosed example, components described in a variety of examples do not necessarily mean essential components and some may be selective components. Thus, an example composed of a subset of components described in an example is also included in the scope of the present disclosure. Thus, an example which additionally includes another component in components described in various examples is also included in the scope of the present disclosure.

In the disclosed example, expressions of location relations used in the specification such as “upper”, “lower”, “left” and “right” are described for convenience of description, and in case drawings illustrated in the specification are inversed, the location relations described in the specification may be inversely understood.

For purposes of this application and the claims, using the exemplary phrase “at least one of: A; B; or C” or “at least one of A, B, or C,” the phrase means “at least one A, or at least one B, or at least one C, or any combination of at least one A, at least one B, and at least one C. Further, exemplary phrases, such as “A, B, or C”, “at least one of A, B, and C”, “at least one of A, B, or C”, etc. as used herein may mean each listed item or all possible combinations of the listed items. For example, “at least one of A or B” may refer to (1) at least one A; (2) at least one B; or (3) at least one A and at least one B.

The term “module” or “unit” used in the specification means a software and/or hardware component, and the “module” or “unit” performs certain operations/functions/roles. However, the “module” or “unit” is not construed as being limited to software or hardware. The “module” or “unit” may be configured to be in an addressable storage medium or to execute one or more processors. Therefore, as an example, the “module” or “unit” may include at least one of components such as software components, object-oriented software components, class components, and task components, processes, functions, attributes, procedures, sub-routines, segments of program codes, drivers, firmware, micro-codes, circuits, data, databases, data structures, tables, arrays, or variables. Functions provided in the components, “modules”, or “units” may be combined into a smaller number of components, “modules”, or “units” or further divided into additional components, “modules”, or “units”.

In the present disclosure, the “module” or “unit” may be realized as a processor and a memory. The “processor” should be widely construed to include a general-purpose processor, a central processing unit (CPU), a microprocessor, a digital signal processor (DSP), a microcontroller, a state machine, or the like. In some environments, the “processor” may refer to an application-specific integrated circuit (ASIC), a programmable logic device (PLD), or a field-programmable gate array (FPGA), and the like. For example, the “processor” may refer to a combination of processing devices such as a combination of a DSP and a microprocessor, a combination of a plurality of microprocessors, a combination of one or more microprocessors combined with a DSP core, or any other such combination. Moreover, the “memory” should be widely construed to include any electronic component capable of storing electronic information. The “memory” may refer to various types of processor-readable medium such as a random access memory (RAM), a read only memory (ROM), a non-volatile random access memory (NVRAM), a programmable read only memory (PROM), an erasable programmable read only memory (EPROM), an electrically erasable programmable read only memory (EEPROM), a flash memory, a magnetic or optical data storage device, and registers. When the processor can read information from a memory and/or record the information in the memory, the memory may be in a state of electronic communication with a processor. Memory integrated into a processor is in a state of electronic communication with the processor.

The one or more features described herein may be provided as a computer program stored in a computer-readable recording medium in order to be executed on a computer. The medium may either continuously store a computer-executable program or temporarily store the program for execution or download. Furthermore, the medium may be a variety of recording or storage means in the form of a single hardware device or multiple combined hardware devices, and is not limited to media directly connected to some computer system but may also be distributed across a network. Examples of such media include magnetic media such as a hard disk, a floppy disk, or a magnetic tape, optical recording media such as a CD-ROM or a DVD, magneto-optical media such as a floptical disk, and a ROM, RAM, or flash memory, among others, configured to store program instructions. Additional examples of such media include media or storage media that are managed by an app store that distributes applications or by various other sites or servers that provide or distribute software.

In a hardware implementation, processing units used for performing the techniques may be implemented within one or more ASICS, DSPS, signal processing devices, programmable logic devices, field-programmable gate arrays, processors, controllers, microcontrollers, microprocessors, electronic devices, or computers or combinations thereof designed to perform the functions described in the present disclosure.

An automation level of an autonomous driving vehicle may be classified as follows, according to the American Society of Automotive Engineers (SAE). At autonomous driving level 0, the SAE classification standard may correspond to “no automation,” in which an autonomous driving system is temporarily involved in emergency situations (e.g., automatic emergency braking) and/or provides warnings only (e.g., blind spot warning, lane departure warning, etc.), and a driver is expected to operate the vehicle. At autonomous driving level 1, the SAE classification standard may correspond to “driver assistance,” in which the system performs some driving functions (e.g., steering, acceleration, brake, lane centering, adaptive cruise control, etc.) while the driver operates the vehicle in a normal operation section, and the driver is expected to determine an operation state and/or timing of the system, perform other driving functions, and cope with (e.g., resolve) emergency situations. At autonomous driving level 2, the SAE classification standard may correspond to “partial automation,” in which the system performs steering, acceleration, and/or braking under the supervision of the driver, and the driver is expected to determine an operation state and/or timing of the system, perform other driving functions, and cope with (e.g., resolve) emergency situations. At autonomous driving level 3, the SAE classification standard may correspond to “conditional automation,” in which the system drives the vehicle (e.g., performs driving functions such as steering, acceleration, and/or braking) under limited conditions but transfer driving control to the driver when the required conditions are not met, and the driver is expected to determine an operation state and/or timing of the system, and take over control in emergency situations but do not otherwise operate the vehicle (e.g., steer, accelerate, and/or brake). At autonomous driving level 4, the SAE classification standard may correspond to “high automation,” in which the system performs all driving functions, and the driver is expected to take control of the vehicle only in emergency situations. At autonomous driving level 5, the SAE classification standard may correspond to “full automation,” in which the system performs full driving functions without any aid from the driver including in emergency situations, and the driver is not expected to perform any driving functions other than determining the operating state of the system. Although the present disclosure may apply the SAE classification standard for autonomous driving classification, other classification methods and/or algorithms may be used in one or more configurations described herein.

One or more features associated with autonomous driving control may be activated based on a layer-based hierarchical control that enables independent software and hardware updates in a software-defined vehicle (SDV). In particular, autonomous driving functions may be distributed across multiple layers—such as a driver layer, a zonal layer, and a vehicle integration layer—that communicate via standardized interfaces, allowing autonomous driving algorithms or sensing modules to be updated or replaced without modifying hardware-dependent components.

For example, when a perception algorithm in the vehicle integration layer is updated to improve object recognition accuracy (e.g., integrating LiDAR fusion with radar-based obstacle tracking), the update may be applied independently from the lower-level driver logic controlling steering, braking, or acceleration actuators. In another example, when a new steering actuator module or braking controller is introduced in a specific zone, the zonal controller may automatically synchronize control parameters with the existing autonomous driving control software via standardized communication, ensuring consistent trajectory and path-following performance without requiring a rewrite of the upper-level software.

Additionally, over-the-air (OTA) updates may selectively upgrade only specific autonomous driving subfunctions (e.g., lane keeping control, forward collision warning, adaptive cruise control, or acceleration rate control) while maintaining stable operation of hardware-related components. Through such modular and hierarchical coordination, autonomous driving control can evolve continuously while ensuring compatibility, safety, and reliability across all system layers.

One or more auxiliary devices (e.g., an engine brake, an exhaust brake, a hydraulic retarder, an electric retarder, a regenerative brake, or the like) may also be controlled based on a feature of layer-based hierarchical control enabling independent software and hardware updates in a software-defined vehicle (SDV). In particular, each auxiliary device may be managed through coordination among a driver layer, a zonal layer, and a vehicle integration layer via standardized interfaces, allowing braking and energy-recovery functions to be flexibly updated or replaced without modifying other layers of the system.

For example, when a regenerative braking algorithm in the driver layer is updated to optimize energy recovery efficiency, the update may be applied independently from the zonal or integration layers, while still maintaining synchronized braking torque distribution through standardized communication. In another example, when a hydraulic retarder module in a specific zone is replaced with a higher-capacity model, the zonal controller may automatically recalibrate local braking parameters while maintaining compatibility with vehicle-level braking coordination logic. Additionally, during an over-the-air (OTA) software update, braking control parameters across different auxiliary devices may be updated selectively—for instance, applying new regenerative braking logic without changing the hardware configuration of the exhaust or engine brake systems. Through such hierarchical control and modular update capability, the SDV architecture ensures stable and efficient management of auxiliary devices while supporting hardware evolution and continuous software improvement.

One or more communication devices (e.g., a modem, a network adapter, a radio transceiver, an antenna, or the like) may also be controlled based on a feature of layer-based hierarchical control enabling independent software and hardware updates in a software-defined vehicle (SDV). In particular, each communication device may interact with a corresponding driver in a driver layer and a zonal controller in a zonal layer through standardized interfaces, allowing the communication function to be updated or reconfigured without modifying other layers of the system.

For example, when a new wireless communication protocol (e.g., 5G New Radio (NR) or vehicle-to-everything (V2X)) is added to support low-latency data exchange for autonomous driving, only the driver layer's software stack may be updated while maintaining compatibility with existing zonal control and vehicle integration logic. In another example, when a physical component such as an antenna module or transceiver board is replaced due to hardware degradation, the zonal controller may automatically recognize the new hardware through the standardized interface and synchronize its configuration parameters without requiring vehicle-level reprogramming. Additionally, over-the-air (OTA) updates delivered via a communication module may be routed to individual layers independently, enabling selective updates of specific functions (e.g., telematics firmware, infotainment connectivity, or V2X applications) while maintaining overall system stability.

Through such hierarchical management, communication devices can adapt dynamically to hardware upgrades, protocol changes, or software deployments, ensuring continuous and reliable network operation in the SDV.

Minimum risk maneuver (MRM) operation(s) may also be controlled based on a feature of layer-based hierarchical control enabling independent software and hardware updates in a software-defined vehicle (SDV). In particular, an MRM control apparatus may cooperate across a driver layer, a zonal layer, and a vehicle integration layer through standardized interfaces to ensure safe vehicle recovery during abnormal conditions. For example, when a perception or braking-control algorithm in the driver layer is updated to improve obstacle detection or braking responsiveness, the vehicle integration layer may seamlessly coordinate with zonal controllers to perform a controlled deceleration and lateral positioning maneuver without requiring software modification in higher or lower layers.

In another example, when a braking actuator or steering module in a specific zone is replaced or recalibrated, the corresponding zonal controller may automatically adjust local control parameters for MRM execution while maintaining overall coordination through the standardized interface. During an over-the-air (OTA) software update or sensor fault, the hierarchical control structure may enable the vehicle integration layer to temporarily delegate control authority to zonal or driver layers, allowing a minimal-risk stop on the shoulder or a safe deceleration within the lane. Through such hierarchical coordination, MRM operations can adapt dynamically to software updates or hardware variations while maintaining stable and fail-safe control behavior.

Biased driving operation(s) may also be controlled based on a feature of layer-based hierarchical control enabling independent software and hardware updates in a software-defined vehicle (SDV). In particular, a driving control apparatus may perform biased driving control by coordinating between a driver layer, a zonal layer, and a vehicle integration layer through standardized interfaces. For example, when a lateral control algorithm in the driver layer is updated to improve lane-keeping accuracy or side-distance estimation, the updated control logic may be applied independently without modifying the zonal control logic or vehicle integration software.

In another example, when a steering actuator or a lateral-position sensor in a specific zone is replaced or recalibrated, the zonal controller may automatically adjust bias parameters for lateral control using updated hardware profiles while maintaining seamless vehicle operation. Furthermore, during over-the-air (OTA) deployment of a new driving model in the vehicle integration layer, the zonal and driver layers may temporarily assume localized control to maintain a safe biased lateral distance from adjacent vehicles or lane boundaries until synchronization is complete. Through such hierarchical coordination, biased driving operations can adapt dynamically to software updates or hardware variations while ensuring consistent safety and stability across driving zones.

One or more sensors (e.g., IMU sensors, cameras, LiDAR, RADAR, blind spot monitoring sensors, line departure warning sensors, parking sensors, light sensors, or rain sensors) may be controlled based on a feature of layer-based hierarchical control enabling independent software and hardware updates in a software-defined vehicle (SDV). In particular, each sensor may communicate with a corresponding driver in a driver layer and a zonal controller in a zonal layer through standardized interfaces, allowing sensor-level software to be updated or reconfigured without modifying associated hardware modules (e.g., lens assemblies, antenna arrays, or transceiver circuits).

For example, when a LiDAR sensor's object-detection algorithm is updated to improve obstacle recognition accuracy, the update may be deployed only within the driver layer without requiring modification of zonal control logic or vehicle integration software. Likewise, when a radar unit or camera is replaced with a model having a different communication protocol, the zonal layer may automatically adapt to the hardware change via the standardized interface, ensuring continued perception functionality. In another example, the vehicle integration layer may dynamically reassign sensor fusion tasks among available zones when a local hardware fault occurs, maintaining perception continuity for autonomous driving control. Through such hierarchical control, sensor operation, updates, and replacements can be independently managed while preserving safe and stable vehicle operation.

An autonomous driving level and/or autonomous driving activation or deactivation may also be controlled based on a feature of layer-based hierarchical control enabling independent software and hardware updates in a software-defined vehicle (SDV). In particular, an autonomous driving control apparatus may determine whether to activate or deactivate autonomous driving based on data exchanged through standardized interfaces among a driver layer, a zonal layer, and a vehicle integration layer.

For example, when software related to perception, planning, or actuation control is updated in the driver layer without modifying hardware components (e.g., sensors, cameras, or steering actuators), the autonomous driving control apparatus may verify compatibility with a zonal controller and perform a gradual transition between autonomous driving levels. Additionally, when hardware in a particular zone (e.g., a LiDAR sensor or wheel-angle actuator) is replaced or updated independently from the software layers, the hierarchical control structure may enable the zonal layer to adapt autonomously while maintaining continuous vehicle control through the vehicle integration layer. In another example, an over-the-air (OTA) update of an autonomous driving algorithm executed in the vehicle integration layer may temporarily deactivate the autonomous driving function until verification of data integrity and synchronization among the layers is completed. Once validated, the autonomous driving mode may be automatically re-activated without requiring hardware reset or driver intervention. Through this structure, the vehicle can ensure safe and stable autonomous operation while allowing independent upgrades of software and hardware components.

A vehicle architecture has changed in an order of a distributed architecture, a domain architecture, and a zonal architecture. The zonal architecture is currently and mainly discussed in conjunction with a software-defined vehicle (SDV).

The zonal architecture is a scheme which inserts a high-performance computer (HPC) into the center to integrate many functions into a central computer, which is the most noteworthy architecture for the SDV, but has the following structural limitations.

### 1) Limit of Real-Time Processing Power

A zonal controller is bound to show its limit in real-time performance. The zonal controller uses a scheduler of an operating system (OS) for efficient resource management to integrate a wide variety of controllers into one controller and integrate a body, a chassis, and a power transmission system, for example, a power train (PT) controller. However, the scheduler of such a type of large OS is unable to perform a task within a fixed time as it takes time to perform context switching. The PT controller may actually solve the problem using a dedicated timer, such as an enhanced time processor unit (eTPU) or a generic timer module (GTM), a dedicated co-processor, or the like, but the zonal controller is unable to load such a function, because it is a general-purpose CPU. In other words, a range controllable by the zonal control structure should be limited to a body control zone which does not have an influence on safety and performance.

### 2) Limit to Integrated Control Performance According to Distributed Structure

The domain architecture has an advantage in which it is possible to be connected with the same network between controllers to immediately perform cooperative/integrated control. On the other hand, the zonal architecture has a problem in which it is difficult to perform safe control when a vehicle should be controlled in an integrated manner within a quick time, because even a function in one controller is distributed to 3 and 4 controllers. In other words, chassis control needing integrated control, as a control function according to a physical zone position is distributed, may have degraded control performance. For example, a Vehicle Dynamic Control (VDC) should adjust and control a driving force/braking force in a desired direction when under/over steer occurs to be different from a driver's intention in a vehicle while driving. The SDV may measure revolutions per minute (RPM) of four wheels or the like to control the driving force/braking force, but difficulty may occur in vehicle control because a corresponding function is distributed for each zone to the zonal controller. For example, in a scheme which controls the chassis in the zonal architecture, a measurement time for each zone may differ because each zone controller calculates a wheel speed, a torque value, or the like, it may take transmission time to transmit the calculated value to a controller for integrated control (e.g., one of zonal controllers or an HPC), it may take transmission time to collect a value transmitted from the integrated controller to calculate an amount of control and re-transmit a corresponding value to a controller for each zone, and an operation time for each zone may differ because a zonal controller of each zone performs each control.

3) Excessive Integration Between Controllers with Different Characteristics

A vehicle controller has a different feature depending on an application field. Thus, the selection of a power source and an MCU may be carefully performed, but the zonal controller may fail to include all of such characteristics. In other words, several auxiliary MCUs are required to has such characteristics. This hinders an efficient design.

According to the present disclosure, a layer-based software-defined vehicle (SDV) architecture is provided, which organizes a vehicle's control and structure software into multiple hierarchical layers to enhance flexibility, independence, and update capability of vehicle systems. The architecture may include a driver layer configured to perform operation and control of a physical layer that includes individual devices of the vehicle, such as motors, actuators, and sensors, a zonal layer configured to manage each predetermined zone of the vehicle and deliver control signals to corresponding drivers, a vehicle integration layer including an integrated controller (e.g., a high-performance computer) configured to perform integrated control of the zonal controllers and coordinate powertrain, chassis, and safety functions; and an IT service layer configured to interface with external services such as cloud servers or user applications. By defining clear hierarchical boundaries and using standardized interfaces between layers, the architecture may achieve complete decoupling between hardware and software, enabling easier updates, efficient resource management, and secure data-based connectivity. This layer-based approach may collect the advantages of both domain-based and zonal-based architectures, thereby ensuring real-time control performance while maintaining high scalability, modularity, and stability of software across diverse vehicle configurations.

Examples of the present disclosure are the gist of collecting only advantages of a domain architecture and a zonal architecture via the layer-based SDV architecture to ensure software flexibility and independence.

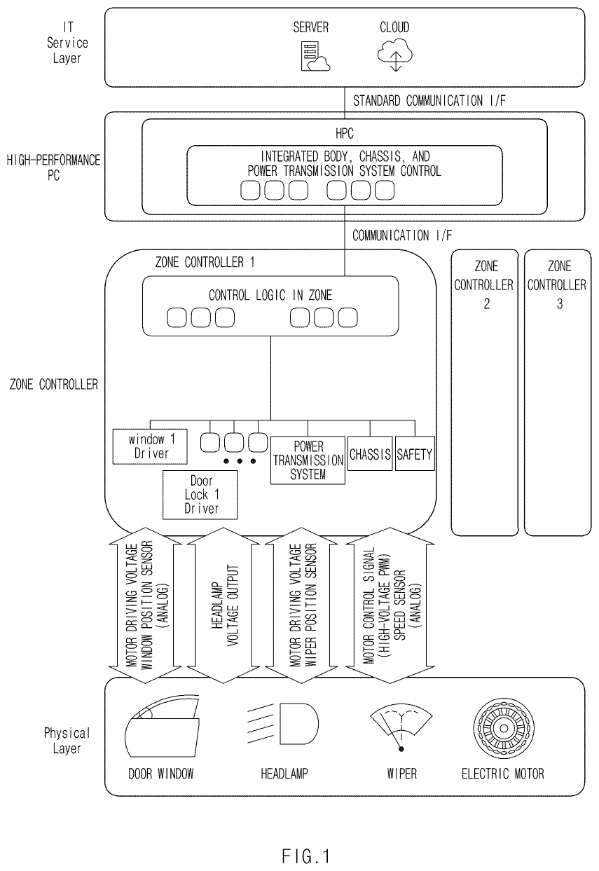

FIG. 1 shows an exemplary drawing for a zonal architecture.

As shown in FIG. 1, the zonal architecture may include a zone controller (or a zonal controller) for controlling each area or zone. Because there are control logic and driver logic for driving hardware in each zone controller, each zone controller may control each individual device constituting a physical layer, for example, a door window, a headlamp, a wiper, an electric motor, or the like using the driver logic (e.g., a door actuator, a window lifter, a headlamp, a wiper motor, an electric mirror, a seat adjustment actuator, etc.). In other words, each zone controller may control an individual device configured in each zone using the driver logic.

Furthermore, a high-performance computer (HPC) may perform chassis control, power transmission system control (e.g., powertrain control, motor torque control, or regenerative braking control, etc.), safety control (e.g., airbag deployment, anti-lock braking, or traction control), and the like as well as integrated body control via each zone controller in an integrated manner.

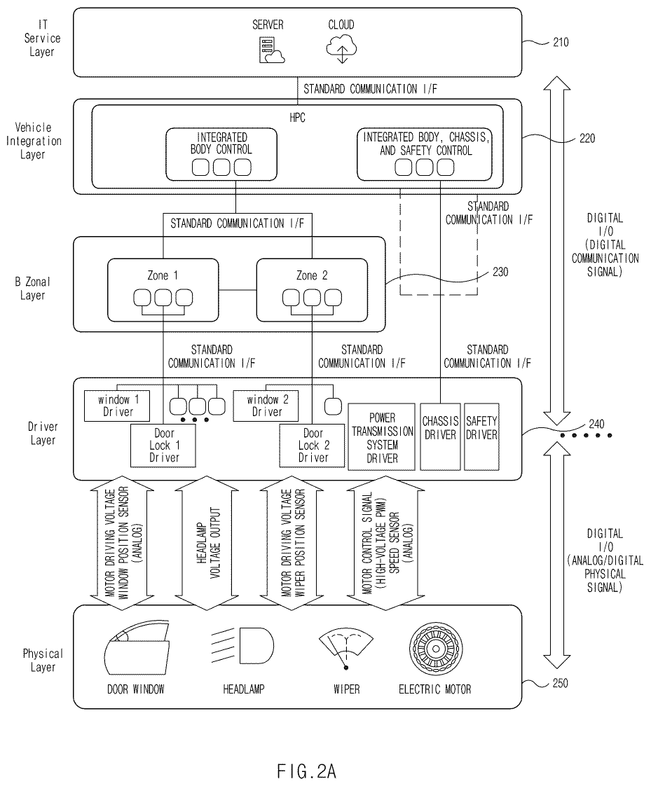

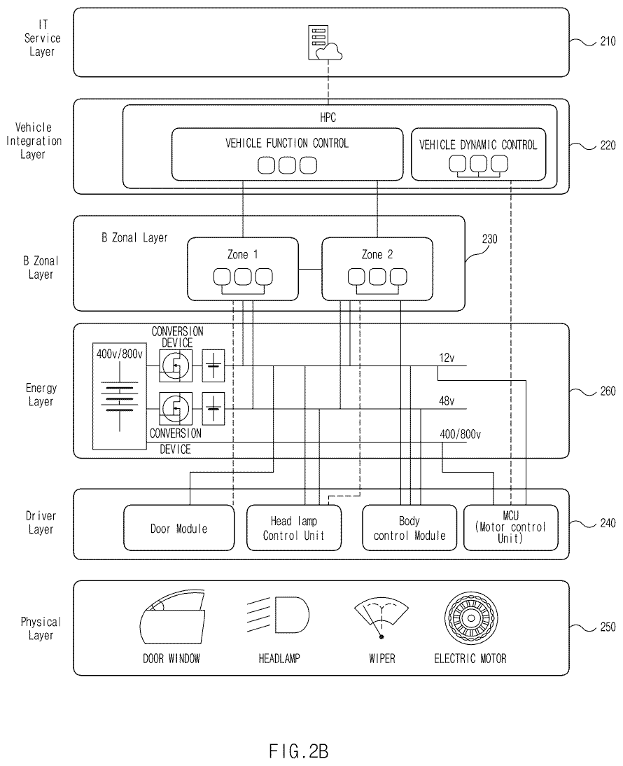

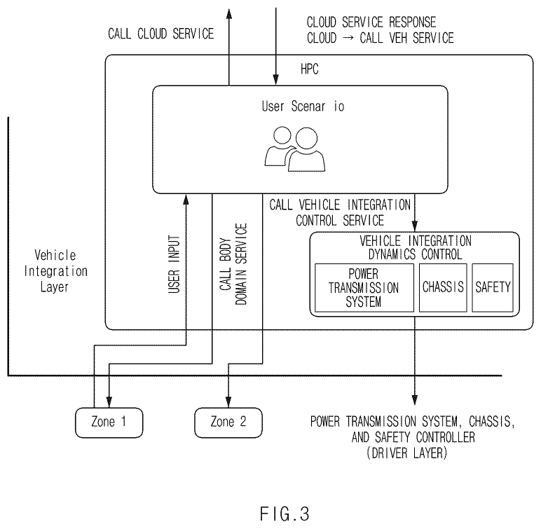

FIG. 2A shows an example of a layer-based software-defined vehicle (SDV) architecture according to an example of the present disclosure. FIG. 2B shows an exemplary drawing for a layer-based software-defined vehicle (SDV) architecture including an energy layer. FIG. 3 shows an exemplary drawing for describing an operation in an HPC.

Referring to FIG. 2A, the layer-based SDV architecture according to an example of the present disclosure may hierarchize an SDV to define an IT service layer 210, a vehicle integration layer 220, a zonal layer (e.g., a B zonal layer 230), and a driver layer 240. The IT service layer 210, the vehicle integration layer 220, the B zonal layer 230, and the driver layer 240 may be connected with each other via a standardized interface (e.g., Ethernet, controller area network (CAN), or local interconnect network (LIN)).

A physical layer 250 may correspond to all actuators or individual devices which are finally driven in a vehicle, which may correspond to an engine of the vehicle, an electric motor of an electric vehicle, a door actuator of the vehicle, a headlamp of the vehicle, a wiper of the vehicle, a brake actuator, a steering actuator, or the like. The physical layer 250 may be electrically connected with the driver layer 240 and may be connected with the driver layer 240 via a non-standard interface (e.g., direct analog/digital I/O, pulse-width modulation (PWM), or serial communication line). The physical layer 250 may be driven by signal such electrical output a as an voltage/current/pulse width modulation (PWM) or the like. The physical layer 250 may be composed of a part which operates depending on the output of a driver constituting the driver layer 240 and a sensor signal for outputting operation information of the driver (e.g., feedback from a position sensor, a current sensor, or a Hall-effect sensor). Local determination may be performed by the driver. The physical layer 250 may perform only a physical operation, for example, without executing software-based decision logic.

The driver layer 240 may include drivers for receiving a signal or a control signal from the B zonal layer 230 and operating/controlling the actuator of the physical layer 250. Each driver may operate or control each actuator constituting the physical layer 250 depending on the signal or the control signal delivered from each B zonal layer 230 (e.g., a door zone controller sending an open/close signal to a door actuator).

At this time, the driver layer 240 may communicate and operate with the B zonal layer 230 which is an upper layer using a standardized message via a controller area network (CAN), a local interconnect network (LIN), Ethernet, or other automotive communication protocols and may operate with the physical layer 250 which is a lower layer via a non-standard input/output (I/O). in other words, an SDV architecture according to an example of the present disclosure is able to respond to changes in various pieces of hardware via only a change in driver (e.g., when an actuator model, a sensor type, or a supplier-specific hardware module is replaced), thus improving flexibility.

Because communication with an upper layer is connected via only a fixed message format via the standard I/O and it is connected with the physical layer 250 via only communication, it is possible to perform perfect software/hardware decoupling (e.g., a software update can be executed without hardware replacement, and vice versa).

In addition, as shown in FIG. 2B, the driver layer 240 may receive power necessary for an operation of the physical layer 250 via an energy layer 260 (e.g., for supplying 12 V, 48 V, or high-voltage power).

The driver layer 240 may include a body driver for operating/controlling the actuator of the physical layer 250 via communication with the B zonal layer 230 and a power transmission system driver, a chassis driver, and a safety driver for performing power transmission system operation or control (e.g., power train operation/control, power electronic operation/control, or the like), chassis operation or control (e.g., suspension damping, steering assistance, or brake control), and safety operation or control (e.g., collision avoidance, stability control, or emergency braking) via communication with the vehicle integration layer 220.

The energy layer 260 may include a power conversion device for performing power-to-power conversion with a power grid for each operating voltage (e.g., 12 V, 48 V, or 400/800 V conversion levels). The advent of electric vehicles diversifies power sources in the vehicle. The power source in the vehicle operates as 12 V, 48 V, a high voltage (e.g., 400/800 V), or the like. A main purpose for each voltage may be the same as Table 1 below.

TABLE 1

| Power source | Purpose |
|---|---|
| 12 V | General control in vehicle, general convenience |
| | function |
| 48 V | High-power consumption device (A/C, electric |
| | heater, headlamp, MDPS, or the like) |
| High voltage | Vehicle driving power source, supply source of |
| (400/800 V) | 12/48 V |

The energy layer 260 may supply a power source for each voltage to all layers of the vehicle in the same form as a backbone of the entire vehicle (e.g., distributing 12 V for control units, 48 V for auxiliary loads, and high voltage for traction inverters).

The B zonal layer 230 may include zone controllers (e.g., Zone 1, Zone 2, and the like) for performing zone control for each predetermined zone (e.g., a front zone controller, a rear zone controller, or a cabin zone controller) and may deliver a control signal to a driver of the zone to control an operation of an individual device included in the physical layer 250 of the zone (e.g., lighting, HVAC, or window control in a corresponding area).

The B zonal layer 230 in the disclosed example is similar to a structure of an existing zonal architecture. However, unlike the existing zonal architecture, the zone controller may perform device control of the zone and an integrated controller included in the vehicle integration layer 220, for example, an HPC may perform integrated control for each vehicle. Herein, the zone controller may include a zonal controller (e.g., a module managing intra-zone communication or aggregating sensor data from devices).

In a difference between the SDV architecture according to the disclosed example and the existing zonal architecture, because there are separately the driver layer and the physical layer in a lower portion, hardware control is performed via the standardized interface (e.g., the CAN/LIN, or Automotive Ethernet) and power transmission system control (e.g., PT control, power distribution, torque management, or battery charging, etc.), chassis control (e.g., steering or braking), and safety control (e.g., collision prevention or occupant protection) are excluded from zone control and are performed in the vehicle integration layer 220. In other words, the B zonal layer 230 may perform only body control of the vehicle (e.g., lighting, door, or HVAC control).

The vehicle integration layer 220 may include an integrated controller (e.g., a high-performance computer (HPC), a domain control unit (DCU), or a central computing module, etc.). The integrated controller may control each zone controller included in the B zonal layer 230 in an integrated manner and may perform power transmission system control, chassis control, and safety control (e.g., coordinating powertrain, braking, and steering functions across all zones).

The vehicle integration layer 220 may be a final stage that a user encounters, which may determine a predetermined external service (e.g., navigation guidance, infotainment update, or vehicle status monitoring), when receiving a user input and invoke the predetermined external service based on a user experience (UX)-based user scenario, and may request execution of the predetermined external service including a body domain service or a vehicle dynamics control service (e.g., controlling lighting, HVAC, or chassis stability functions).

For example, as shown in FIG. 3, when a user input is received from Zone 1 of the B zonal layer 230, the vehicle integration layer 220 may determine a body domain service based on a UX-based user scenario to provide or activate the body domain service to Zone 1 (e.g., turning on interior lights, adjusting seat position, or opening windows), may call a VEH service from the IT service layer 210 via response of the IT service layer 210 when calling a cloud service to the IT service layer 210 based on the user scenario (e.g., remote climate control, over-the-air diagnostics, or parking assistance updates), and may call a vehicle integrated control service based on the user scenario to deliver a control signal to the power transmission system driver (or controller or control device), the chassis driver (or controller or control device), and the safety driver (or controller or control device) of the driver layer 240, thus performing vehicle integration dynamics control (e. g., coordinating acceleration, steering, and braking commands).

A description will be given of an example for an external service. When a user requests a server to check a state of a vehicle via a user application (e.g., requests the server to check whether a window is opened using a smartphone app, a smartwatch interface, or an in-home voice assistant), the server may call a check request service to the vehicle. The HPC may check a zone in the vehicle and a service based on the service and may provide a service request (e.g., call a window state check service, a door lock status service, or a battery state-of-charge inquiry) to a corresponding zone controller. The zone controller may receive the service request from the HPC and may request a corresponding driver to check a vehicle state via a standard interface. The driver may check a window state and transmit vehicle state information (e.g., open, closed, or partially open) to the user application in a reverse order.

A description will be given of another example for the external service. When the user requests the server to operate the vehicle via the user application (e.g., requests the server to perform a window ventilation operation, start remote charging, or unlock the doors, etc.), the server may call an operation request service to the vehicle. The HPC may check a zone in the vehicle and a service based on the service and may provide a service request (e.g., call a vehicle window operation service or a cabin temperature preconditioning service) to the zone controller. The zone controller may receive the service request from the HPC and may deliver a hardware operation request signal to the driver via the standard interface. The driver may perform the window ventilation operation and may transmit operation result data (e.g., window ventilation operation information such as window position or target temperature reached, etc.) to the user application in a reverse order.

A driving mode change may be included as an example for an inter-vehicle service (e.g., switching between Eco, Normal, or Sport modes). A driving mode change service may recognize an input via a zone controller of a B zonal layer and may notify the HPC of a user request (or deliver the user request to the HPC), when it is input via the driver layer or a driving mode button is immediately input via a user input. The HPC may determine whether to permit a current input mode based on UX and may directly transmit and feedback a driving mode change command to the zone controller corresponding to a driving mode. At this time, the HPC may display whether it is normally reflected on the zone controller, a cluster, or head-up display (HUD).

Because a fast response speed and integrated control are required for vehicle integration dynamics control (e.g., during coordinated braking and steering or stability correction events), the HPC may directly perform integrated control and the driver layer may perform direct control of each individual device (e.g., actuator, motor, or valve).

The IT service layer 210 may refer to a layer for an IT-based service, such as an external web service, a smartphone application, a cloud-based big data service, or a voice control assistant.

The IT service layer 210 may perform a function processed by the service, when the application or the HPC provides a request to the vehicle or the vehicle requests a web-based service (e.g., real-time navigation updates, software patch downloads, or personalized driver profile synchronization).

The layer-based SDV architecture according to an example of the present disclosure may provide 1) continuous performance/function improvement via an update, 2) new user experience expansion via software (e.g., installation of new software, installation of optional driving-assist, or infotainment features, etc.), and 3) a data-based connectivity service (e.g., predictive maintenance, fleet monitoring, or cloud analytics). A description will be given below of them.
1) Continuous performance/function improvement via update
2) SW update requirement 1-independence acquisition.

The core of executing a software update function is achieved by ensuring independence between respective elements. The most representative example of ensuring software independence is OSI 7 layer of the network and a JAVA virtual machine (e.g., both maintain modularity and portability between layers).

Open system interconnection (OSI) defines a layer from the physical layer which is the lowest layer in the network to the application the user encounters and delivers data between respective layers using a standardized interface (e.g., TCP/IP or HTTP protocol stack) to be able to be developed even without a deep knowledge of another layer and to be independent of even a change in the other layer not to have an influence on the change in the other layer. A Java virtual machine (JVM) needs to separately make/compile software for each OS. However, as a code converted into a Java bytecode on the JVM is executed in the JVM of each OS, it is possible to be executed regardless of the OS (e.g., Windows, Linux, or Android).

### 1) SW Update Requirement 2—Hierarchy and Standardization

It may be checked that the most important element for ensuring independence between elements is hierarchy and standardization, via the examples of the OSI 7 layer and the JVM (e.g., using standard APIs, layered abstraction, or modular build systems).

### 1) Hierarchy and Standardization of Hierarchical-Based SDV Architecture

The layer-based SDV architecture may include a driver layer to pursue definite separation. Because it is based on a standard CAN/LIN message between a B zonal layer and the driver layer, it is unnecessary to change a zone controller, even upon a change in part for each vehicle type and a change in specifications according to a vehicle's year. In other words, according to the independence expansion, it may be advantageous to respond to the change in specifications and software stability may be improved (e.g., allowing version updates, hardware replacements, or ECU reassignments without cross-impact).

On the other hand, because the zonal architecture includes a driver in the zone controller and needs to change hardware or software of the driver upon a change in hardware occurs, the architecture according to the disclosed example has an advantageous advantage compared to an existing zonal architecture in terms of hardware decoupling (e.g., enabling plug-and-play device replacement, platform scaling, or modular upgrades).

### 2) User Experience Expansion via Software

Software expandability is an element that the user most expects in the SDV. Expandability refers to adding controllable software of a vehicle system, rather than simply installing an app in an infotainment system, and means that the user is able to freely use a hardware resource in the vehicle in an allowable range (e.g., enabling new driver-assist algorithms, lighting patterns, or energy-management modes). Such expandability may be provided via a policy and a user-defined area (e.g., defining which software or functions a user is permitted to install or modify).

The layer-based SDV architecture according to the disclosed example may be configured based on a zone and an HPC to be able to be configured as basically the same software platform as the zonal architecture and may apply the user-defined area and the policy to the zone and the HPC to be able to be expand installation or experience of software desired by the user (e.g., personalized ambient lighting themes, autonomous-parking routines, or third-party energy-efficiency modules).

### 3) Security Policy for Data-Based Connectivity

The SDV is always connected with a data network to perform bidirectional data communication in real time (e.g., vehicle-to-cloud, vehicle-to-infrastructure, or vehicle-to-vehicle communication). Because the most important thing is the security of information, it requires consistency and contact control of a security policy, for example, to prevent unauthorized communication, malicious updates, or data tampering.

The layer-based SDV architecture according to the disclosed example may perform contact control via the HPC and may be subject to a consistent security policy around the HPC to obtain a safe structure even under cybersecurity threats (e.g., external hacking, spoofing, or malware injection).

In addition, the layer-based SDV architecture according to the disclosed example may perform direct and low-latency control in a driver layer to facilitate a microcontroller unit (MCU) configuration optimized for a driver and ensure quick and stable vehicle control performance (e.g., instantaneous brake actuation, steering torque control, or lighting response). As an integrated range in a zone controller is limited to body control, a portion needing quick processing may be directly performed in each driver of the driver layer without routing through upper-layer logic.

Furthermore, the layer-based SDV architecture according to the disclosed example may perform driving layer distribution of the function of the zonal controller to have the effect of lowering the security level required per controller, for example, by isolating safety-critical functions (e.g., braking or steering) from non-critical ones (e.g., HVAC or infotainment), thereby improving overall system robustness.

As the zonal controller directly drives hardware in the zonal architecture, when hardware should be differently developed according to area or option specifications (e.g., left-hand vs. right-hand drive, luxury vs. base trim, or country-specific equipment), variation increases exponentially. This leads to difficulty of specification management and an increase in cost (e.g., redesigning ECUs, rewriting drivers, or revalidating certification software).

On the other hand, as the layer-based SDV architecture according to the disclosed example is separated from a driver in hardware and only the driver and the actual hardware change depending to a change in specifications, it is possible to maintain the same hardware and software platform across multiple vehicle models (e.g., sedans, SUVs, or EVs) to be free from management and cost issues.

As described above, the layer-based SDV architecture according to an example of the present disclosure may collect advantages of the domain architecture and the zonal architecture to ensure software flexibility and independence, thus ensuring superior performance and scalability (e.g., modular software updates, centralized compute control, and reduced wiring complexity).

Furthermore, the layer-based SDV architecture according to an example of the present disclosure may secure software independence to secure an update, collaboration, and stability of software. For example, when a driver for driving hardware of the physical layer is separately separated and hardware is added or changed, there is a need to correct a zonal controller (or a zone controller) in the zonal architecture. However, there is no need to correct a zone controller in the technology according to the present disclosure. As the driver and the zone controller are connected with each other via the standardized interface (e.g., CAN, LIN, or Automotive Ethernet), there is no need to change software even when changing hardware (e.g., replacing a motor actuator or sensor module).

Furthermore, in layer-based SDV architecture according to an example of the present disclosure, the driver is able to directly control hardware to perform stable and quick control of the hardware and perform stable and quick integrated control even when vehicle integration control is required (e.g., simultaneous coordination of braking, steering, and traction control in an emergency event).

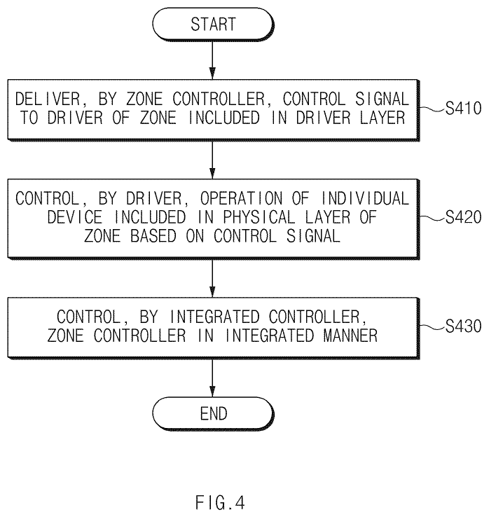

FIG. 4 shows an exemplary operational flowchart for a layer-based software-defined vehicle (SDV) control method according to another example of the present disclosure, which shows an exemplary operational flowchart for a control method using a layer-based SDV architecture of FIGS. 1 to 3.

Referring to FIG. 4, in the layer-based SDV control method according to another example of the present disclosure, in S410, a zone controller which is included a B zonal layer to perform zone control for each predetermined zone for a vehicle may deliver a control signal to a driver of the zone included in a driver layer (e.g., a door control command, light activation command, or HVAC temperature adjustment).

Herein, S410 may be a step of delivering the control signal for controlling an operation of an individual device associated with a body of the vehicle in the zone to the driver of the zone (e.g., a body electronics control function such as window operation, seat position control, or mirror folding).

When the control signal is delivered to the driver in S410, in S420, the driver may control an operation of an individual device included in a physical layer of the zone based on the control signal (e.g., by generating an appropriate output current, voltage, or PWM pattern).

In S430, an integrated controller included in a vehicle integration layer may control the zone controller in an integrated manner (e.g., coordinating lighting intensity across zones, harmonizing HVAC airflow, or synchronizing door lock timing).

In addition, in the layer-based SDV control method according to another example of the present disclosure, the integrated controller may deliver a control signal for power transmission system control, chassis control, and safety control to a power transmission system driver, a chassis driver, and a safety driver of the driver layer (e.g., for torque distribution, suspension damping adjustment, or traction control).

In addition, in the layer-based SDV control method according to another example of the present disclosure, the integrated controller may determine a predetermined external service, when receiving a user input and invoking the predetermined external service based on a UX-based user scenario. The integrated controller may call the predetermined external service including a body domain service or a vehicle dynamics control service (e.g., remote parking, auto-window ventilation, or dynamic stability intervention).

Although the description in the method according to another example of the present disclosure is omitted, it is obvious to those skilled in the art that the method according to the other example of the present disclosure may include all contents described in the architecture of FIGS. 1 to 3.

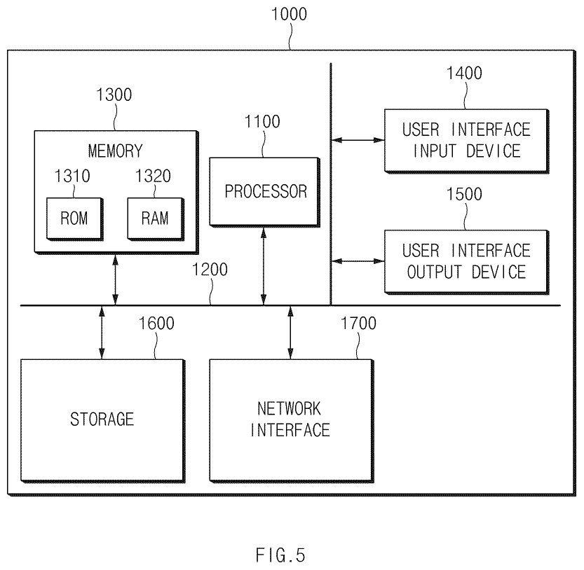

FIG. 5 shows an example of a block diagram of a computing system for executing a layer-based software-defined vehicle control method according to another example of the present disclosure (e.g., the computing system may be implemented as a vehicle control unit, a high-performance computer (HPC), or an embedded controller).

Referring to FIG. 5, the above-mentioned layer-based software-defined vehicle control method according to another example of the present disclosure may be implemented through a computing system. A computing system 1000 may include at least one processor 1100, a memory 1300, a user interface input device 1400, a user interface output device 1500, storage 1600, and a network interface 1700, which are connected with each other via a system bus 1200 (e.g., a high-speed communication bus such as PCIe, CAN-FD, or Ethernet).

The processor 1100 may be a central processing unit (CPU) or a semiconductor device that processes instructions stored in the memory 1300 and/or the storage 1600 (e.g., a microcontroller, a multi-core CPU, or a system-on-chip (SoC)). The memory 1300 and the storage 1600 may include various types of volatile or non-volatile storage media (e.g., dynamic RAM (DRAM), flash memory, or solid-state drive (SSD)). For example, the memory 1300 may include a read only memory (ROM) 1310 and a random access memory (RAM) 1320 (e.g., storing executable instructions, sensor data, or control parameters, etc.).

Accordingly, the operations of the method or algorithm described in connection with the examples disclosed in the specification may be directly implemented with a hardware module, a software module, or a combination of the hardware module and the software module, which is executed by the processor 1100. (e.g., an HPC processor executing real-time control logic for zonal coordination) The software module may reside on a storage medium (i.e., the memory 1300 and/or the storage 1600) such as a RAM, a flash memory, a ROM, an EPROM, an EEPROM, a register, a hard disc, a removable disk, and a CD-ROM. The exemplary storage medium may be coupled to the processor 1100 via the system bus 1200 or a dedicated interface. The processor 1100 may read out information from the storage medium and may write information in the storage medium. Alternatively, the storage medium may be integrated with the processor 1100 in a single package such as an application-specific integrated circuit (ASIC) or SoC. The processor 1100 and the storage medium may reside in an ASIC. The ASIC may reside within a user terminal (e.g., an in-vehicle controller, a gateway module, or a domain control unit). In another case, the processor 1100 and the storage medium may reside in the user terminal as separate components interconnected via a high-speed bus or shared memory interface.

According to an example of the present disclosure, a layer-based software-defined vehicle architecture may include a driver layer including a driver for performing an operation and control for a physical layer including each individual device of a vehicle, a B zonal layer that includes a zone controller for performing zone control for each predetermined zone for the vehicle and delivers a control signal to a driver of the zone to control an operation of an individual device included in a physical layer of the zone, and a vehicle integration layer including an integrated controller for controlling the zone controller in an integrated manner.

According to an example, the driver layer, the B zonal layer, and the vehicle integration layer may be connected with each other via a standardized interface.

According to an example, the zone controller may deliver a control signal for controlling an operation of an individual device associated with a body of the vehicle in the zone to the driver of the zone.

According to an example, the zone controller may include a zonal controller.

According to an example, the integrated controller may deliver a control signal for power transmission system control, chassis control, and safety control to a power transmission system driver, a chassis driver, and a safety driver of the driver layer.

According to an example, the integrated controller may determine a predetermined external service, when receiving a user input and calling the predetermined external service based on a user experience (UX)-based user scenario, and may call the predetermined external service including a body domain service or a vehicle dynamics control service.

In addition, the layer-based software-defined vehicle architecture may further include an energy layer that includes a power conversion device for performing power-to-power conversion with a power grid for each operating voltage and supplies control power and driving power in the vehicle.

According to another example of the present disclosure, a layer-based software-defined vehicle control method may include delivering a control signal associated with a body of a vehicle via each zone, controlling an operation of an individual device included in the zone based on the control signal, and controlling the vehicle including each zone in an integrated manner.

According to an example, the delivering of the control signal may include delivering the control signal via a standardized interface.

According to an example, the controlling of the vehicle in the integrated manner may include performing power transmission system control, chassis control, and safety control.

In addition, the layer-based software-defined vehicle control method may further include determining a predetermined external service, when receiving a user input and calling the predetermined external service based on a UX-based user scenario, and calling the predetermined external service including a body domain service or a vehicle dynamics control service.

The above-described examples may be implemented with hardware components, software components, and/or a combination of hardware components and software components. For example, the devices, methods, and elements described in the examples of the inventive concept may be implemented by using one or more general-use computers or special-purpose computers, such as a processor, a controller, an arithmetic logic unit (ALU), a digital signal processor, a microcomputer, a field programmable gate array (FPGA), a programmable logic unit (PLU), a microprocessor, or any device that may execute instructions and respond. A processing unit may perform an operating system (OS) or one or more software applications running on the OS. Further, the processing unit may access, store, manipulate, process, and generate data in response to the execution of software. It will be understood by those skilled in the art that although a single processing unit may be illustrated for convenience of understanding, the processing unit may include a plurality of processing elements and/or a plurality of types of processing elements. For example, the processing unit may include a plurality of processors or one processor and one controller. Also, the processing unit may have a different processing configuration, such as a parallel processor.

Software may include computer programs, codes, or instructions, or one or more combinations thereof, and may configure a processing unit to operate in a desired manner or may independently or collectively instruct the processing unit. Software and/or data may be permanently or temporarily embodied in any type of machine, component, physical equipment, virtual equipment, computer storage medium, unit, or in transmitted signal waves so as to be interpreted by the processing unit or to provide instructions or data to the processing unit. Software may be dispersed throughout computer systems connected over networks and may be stored or executed in a distributed manner. Software and data may be stored in one or more computer-readable storage media.

The methods according to the above-described examples of the present disclosure may be recorded in computer-readable media including program instructions to implement various operations embodied by a computer. The computer-readable media may also include, alone or in combination with the program instructions, data files, data structures, and the like. The program instructions recorded in the medium may be designed and configured specifically for the examples or be known and available to those skilled in computer software. Examples of computer-readable media include magnetic media such as hard disks, floppy disks, and magnetic tape; optical media such as compact disc-read only memory (CD-ROM) disks and digital versatile discs (DVDs); magneto-optical media such as floptical disks; and hardware devices that are specially configured to store and perform program instructions, such as read-only memory (ROM), random access memory (RAM), flash memory, and the like. Examples of computer programs include not only machine language codes created by a compiler, but also high-level language codes that are capable of being executed by a computer by using an interpreter or the like. The described hardware devices may be configured to act as one or more software modules to perform the operations of the above-described examples, or vice versa.

Even though the examples are described with reference to the accompanying drawings, it will be obvious to one skilled in the art that the examples may be variously changed or modified based on the above description. For example, equivalent effects may be achieved even if the foregoing processes and methods are carried out in a different order than described above, and/or the aforementioned components, such as systems, structures, devices, or circuits, are concatenated or coupled in different forms and modes from those described above or are substituted or switched with other components or equivalents.

The present disclosure may combine advantages of the domain architecture and the zonal architecture to ensure software flexibility and independence via the layer-based SDV architecture, thus ensuring the excellence of performance that the domain architecture has.

The present disclosure may secure software independence to secure update, collaboration, and stability of software. For example, when a driver for driving hardware of the physical layer is separately separated and hardware is added or changed, there is a need to correct a zonal controller (or a zone controller) in the zonal architecture. However, there is no need to correct a zone controller in the technology according to the present disclosure. As the driver and the zone controller are connected with each other via a standardized interface, there is no need to change software even when changing hardware.

According to the present disclosure, the driver is able to directly control hardware to perform stable and quick control of the hardware and perform stable and quick integrated control even when vehicle integration control is required.

The effects that are achieved through the present disclosure may not be limited to the effects described above, and other advantages not described above may be more clearly understood from the following detailed description by those skilled in the art to which the present disclosure pertains.

Hereinabove, although the present disclosure has been described with reference to examples and the accompanying drawings, the present disclosure is not limited thereto, but may be variously modified and altered by those skilled in the art to which the present disclosure pertains without departing from the spirit and scope of the present disclosure claimed in the following claims. Therefore, examples disclosed in the present disclosure are not intended to limit the technical spirit of the present disclosure, and the scope of the technical spirit of the present disclosure is not limited by such an example. The scope of the present disclosure should be construed on the basis of the accompanying claims, and all technical ideas within the scope equivalent to the claims should be included in the scope of the present disclosure.

What is claimed is:

1. An apparatus of a vehicle, the apparatus comprising:
a physical layer associated with a plurality of circuits of the vehicle;
a driver layer configured to perform operation and control of the physical layer;
a zonal layer comprising a plurality of zone controllers configured to:
perform zone control for respective predetermined zones of the vehicle, wherein each respective predetermined zone of the vehicle is associated with a corresponding portion of the physical layer, and
output a control signal to a driver associated with each respective predetermined zone to control an operation of a circuit of the plurality of circuits, wherein the circuit is associated with the corresponding portion of the physical layer; and
a vehicle integration layer comprising an integrated controller configured to control each of the plurality of zone controllers in an integrated manner.

2. The apparatus of claim 1, wherein the driver layer, the zonal layer, and the vehicle integration layer are coupled with each other via a standardized interface, and
wherein at least one of the driver layer, the zonal layer, or the vehicle integration layer is updatable, via the standardized interface, independently from a corresponding physical component of the vehicle.

3. The apparatus of claim 1, wherein the circuit is further associated with a body of the vehicle and included in the respective predetermined zone of the vehicle.

4. The apparatus of claim 3, wherein each zone controller is configured to communicate, via a standardized interface, with a driver associated with a respective predetermined zone.

5. The apparatus of claim 1, wherein the integrated controller is configured to:
provide control signals to a power transmission system driver of the driver layer, a chassis driver of the driver layer, and a safety driver of the driver layer for respectively performing power transmission system control, chassis control, and safety control.

6. The apparatus of claim 1, wherein the integrated controller is configured to:
receive a user input,
determine, based on a user experience (UX)-based user scenario, a predetermined external service corresponding to the user input, and
invoke the predetermined external service, wherein the predetermined external service comprises at least one of a body domain service or a vehicle dynamics control service.

7. The apparatus of claim 1, further comprising:
an energy layer associated with a power conversion circuit configured to:
perform power-to-power conversion between the vehicle and a power grid based on respective operating voltages of the vehicle and the power grid, and
supply control power and driving power to the vehicle.

8. A method performed by an apparatus of a vehicle, the method comprising:
providing, via a standardized interface of the vehicle and by a zone controller of a plurality of zone controllers associated with respective zones of the vehicle, a control signal associated with a body of the vehicle;
controlling, by a driver associated with each respective zone and based on the control signal, an operation of a circuit of a plurality of circuits of the vehicle, wherein the circuit is associated with the corresponding zone; and
controlling, by an integrated controller of the vehicle, each of the plurality of zone controllers in an integrated manner.

9. The method of claim 8, wherein the providing of the control signal comprises:
transmitting the control signal via the standardized interface.

10. The method of claim 8, wherein the controlling of each of the plurality of zone controllers comprises:
performing power transmission system control, chassis control, and safety control.

11. The method of claim 8, further comprising:
receiving a user input;
determining, based on a user experience (UX)-based user scenario, a predetermined external service corresponding to the user input; and
invoking the predetermined external service, wherein the predetermined external service comprises at least one of a body domain service or a vehicle dynamics control service.

12. A vehicle comprising:
a sensor configured to obtain information on the vehicle and a surrounding environment of the vehicle;
an actuator configured to perform a physical operation of the vehicle based on a control signal;
a driver layer configured to operate the actuator based on the control signal;
a zonal layer configured to perform zone control for a predetermined zone of the vehicle and provide the control signal to the driver layer;
a vehicle integration layer configured to control the zonal layer to perform control of at least one of powertrain system, chassis system, or safety system of the vehicle;
interfaces configured to exchange data between the driver layer, the zonal layer, and the vehicle integration layer;
a driving control circuit configured to control autonomous driving of the vehicle; and
a processor circuit configured to:
output, via the interfaces and based on the information obtained by the sensor, driving control signals respectively for controlling the driver layer, the zonal layer, and the vehicle integration layer, and
control, via the driving control circuit and based on the driving control signals, autonomous driving of the vehicle.

13. The vehicle of claim 12, wherein the processor circuit is configured to:
determine, based on information obtained by the sensor, a user experience (UX)-based scenario associated with autonomous driving of the vehicle, and
output the at least one driving control signal based on the UX-based user scenario.

14. The vehicle of claim 12, wherein the processor circuit is configured to:
determine, based on information obtained by the sensor, a user experience (UX)-based user scenario, to identify an external service corresponding to the UX-based user scenario, and
initiate communication with the external service, wherein the external service comprises at least one of a body domain service or a vehicle dynamics control service, wherein the body domain service corresponds to a service associated with at least one of a door, window, lighting, or climate control of the vehicle, and wherein the vehicle dynamics control service corresponds to a service associated with at least one of a powertrain system, a chassis system, or a safety system of the vehicle.

15. The vehicle of claim 12, wherein the processor circuit is configured to transmit, via the interfaces, a control signal to a zone controller of the zonal layer, wherein the zone controller is associated with a respective zone of the vehicle and configured to provide the control signal to a driver of the respective zone to control a circuit associated with a body of the vehicle.

16. The vehicle of claim 12, wherein the processor circuit is configured to control, via the vehicle integration layer, a plurality of zone controllers included in the zonal layer, to perform integrated control of at least two among a powertrain system, a chassis system, and a safety system of the vehicle.

17. The vehicle of claim 12, wherein the processor circuit is configured to perform power-to-power conversion control by transmitting a control signal to a power conversion circuit associated with an energy layer of the vehicle, wherein the power conversion circuit is configured to perform power conversion between the vehicle and a power grid based on respective operating voltages of the vehicle and the power grid.

18. The vehicle of claim 12, wherein the processor circuit is configured to update, via the interfaces, at least one of the driver layer, the zonal layer, or the vehicle integration layer independently from a corresponding physical component of the vehicle.

19. The vehicle of claim 12, wherein the processor circuit is configured to establish, via the interfaces, a connection between a driver of the driver layer and a zone controller of the zonal layer such that a software configuration of the zone controller is not required to be changed when hardware associated with the driver is added or changed.

20. The vehicle of claim 12, wherein the processor circuit is configured to control communication between the driver layer and a physical layer of the vehicle to operate a plurality of circuits of the vehicle, and wherein the plurality of circuits are operated based on respective control signals from the driver layer.
